(19) United States
(12) Patent Application Publication
(10) Pub. No.: US 2007/0100080 A1
(43) Pub. Date: May 3, 2007

(54) METHOD AND APPARATUS FOR PRODUCTION OF POLYVINYL ALCOHOL WITH HIGH DEGREE OF POLYMERIZATION

(75) Inventors: Sam-hun YUN, Daejeon (KR); Seon-wook KIM, Daejeon (KR); Jeong-seok LEE, Daejeon (KR); Sung-tae AHN, Daejeon (KR)

Correspondence Address: CANTOR COLBURN, LLP, 55 GRIFFIN ROAD SOUTH, BLOOMFIELD, CT, 06002, US

(73) Assignee: LG CHEM, LTD., Seoul (KR)

(21) Appl. No.: 11/551,976

(22) Filed: Oct. 23, 2006

(30) Foreign Application Priority Data
Oct. 28, 2005 (KR) 10-2005-0102268

(51) Int. Cl. C08F 8/00

(52) U.S. Cl. 525/330.6

(57) ABSTRACT

The present invention relates to a method and an apparatus for the production of polyvinyl alcohol, and more precisely, a method and an apparatus for the production of polyvinyl alcohol in which the saponification of a mixture of polyvinyl ester solution and a catalyst is induced in a reactor equipped with a planetary stirrer coated with one or more coating agents selected from a group consisting of fluororesin, silicon resin and epoxy resin. According to the present invention, the method and apparatus of the present invention have advantages for the production of polyvinyl alcohol such as inhibiting gelation during the conversion of polyvinyl ester into polyvinyl alcohol, thereby enabling the preparation of polyvinyl alcohol with a high degree of saponification, a high degree of polymerization and high apparent gravity, reducing the amount of a solvent used and thereby requiring a smaller reactor, resulting in the reduction of the apparatus cost and the solvent recovery cost.

This application claims the benefit of the filing date of Korean patent Application No. 10˜2005-0102268 filed on Oct. 28, 2005 in the Korean Intellectual Property Office, the disclosure of which is incorporated herein in its entirety by reference.

### TECHNICAL FIELD

The present invention relates to a method and an apparatus for the production of polyvinyl alcohol, and more precisely, a method and an apparatus for the production of polyvinyl alcohol which is characterized by inhibiting gelation during the conversion of polyvinyl ester into polyvinyl alcohol so as to produce polyvinyl alcohol with a high degree of saponification, a high degree of polymerization and high apparent gravity in a high concentration polyvinyl ester solution, reducing the amount of a solvent used and requiring a smaller reactor, thereby leading to the reduction of apparatus cost and solvent recovery cost.

### BACKGROUND ART

Polyvinyl alcohol was first found by Hermann and Haehnel in 1924 in the course of an experiment on the saponification of polyvinyl acetate. Polyvinyl alcohol is a linear crystalline polymer harboring a hydroxy group and is prepared by the saponification of a vinyl ester polymer such as polyvinyl acetate which exhibits excellent solvent-resistance and oil-resistance. Polyvinyl alcohol has been widely applied to sizing agents, clothes, industrial fibers, separating filters and medical polymers, etc, according to the molecular weight, degree of saponification and stereoregularity.

Recently, studies on the production and application of highly valuable and highly functional polyvinyl alcohol have been actively undergoing. Polyvinyl alcohol can be prepared as a film, in particular as various optical polymer films or further as a polarizing film for LCDs, since it has excellent optical characteristics, including transparency, and exhibits high birefringence during drawing. To be used as a polarizing film, polyvinyl alcohol has to have a high degree of polymerization and a high degree of saponification, which requires high technology. Thus, only a few companies are engaged in producing polyvinyl alcohol usable as a polarizing film.

Polyvinyl alcohol cannot be directly polymerized because of tautomerization of vinyl alcohol monomers. Thus, vinyl ester monomers, specifically vinyl acetate, are first polymerized by emulsion, suspension and/or bulk polymerization to produce polyvinyl ester. Then, the produced polyvinyl ester is treated by continuous or batch saponification.

A representative method for inducing saponification of polyvinyl ester is that polyvinyl ester is dissolved completely in an alcohol solvent and reacted in the presence of a heavy acid or base. It is important in this method to maintain a low concentration of polyvinyl acetate because of the high viscosity of polyvinyl ester solution, in order to produce polyvinyl alcohol with a high degree of polymerization (weight average molecular weight of polyvinyl alcohol: at least 132,000) and a high degree of saponification. If the concentration of polyvinyl acetate is at least 6%, the reaction solution exhibits high viscosity and thereby a normal force exerted by a stirrer with a rod causes ‘rod climbing’, which means the reaction solution or slurry is climbing up the rod of the stirrer during dissolution or phase conversion. As a result, from the saponification of polyvinyl alcohol, a huge lump of gel is generated instead of dispersed particles, which adheres to the stirrer or the reactor wall, making the reaction difficult. To keep the concentration of polyvinyl acetate low, a reactor has to be very big for saponification and thereby the amount of solvent used increases, suggesting an increase in solvent recovery cost and energy cost.

Some patents have been applied which insist that the above problems are solved, though in fact they are still in question.

U.S. Pat. No. 4,954,567 describes a method for producing polyvinyl alcohol wherein the dried polyvinyl acetate particles are slowly added to a solvent containing a catalyst instead of dissolving polyvinyl acetate in a solvent. The inventors claimed that this production method produced polyvinyl alcohol with improved particle shape, apparent gravity and transparency. However, polyvinyl alcohol with a high degree of saponification is still controversial. when the dried polyvinyl acetate is used for saponification by the method disclosed in the above patent, it causes a problem in that polyvinyl acetate becomes a core and polyvinyl alcohol becomes a shell.

U.S. Pat. No. 5,753,753 describes that polyvinyl acetate is dissolved in a solvent, to which an inert material (like sodium bicarbonate) acting as nucleating sites is added before saponification. After dispersing the inert material completely in the polyvinyl acetate solution, a catalyst is added to induce the reaction. According to the inventors, the polyvinyl alcohol produced by the saponification by this method adhered to nucleating sites so as to prevent serious gelation. A problem with this method is that the inert material added to polyvinyl alcohol at the beginning still remains in the final product as an impurity, making the product inappropriate for such films as polarizing plates which require high purity and high transparency.

U.S. Pat. No. 3,884,892 describes a method of producing polyvinyl alcohol with various solvents of different densities. According to this patent, polyvinyl ester solution was topped with an alcohol solvent layer having a low density, which was then topped with a catalyst solution having higher density than that of the alcohol layer. That is, the catalyst solution layer was positioned in between the polyvinyl ester solution and the alcohol solvent layer by means of the difference of density. Then, the reaction was induced by stirring. As a result, according to the inventors, owing to the low density of the alcohol layer, polyvinyl ester droplets were formed and thereby the reaction progressed in a suspension type solution, resulting in the prevention of gelation. However, this method is very complicated and thus difficult to operate.

### DISCLOSURE

[Technical Problem]

To overcome the above problems of the conventional arts, it is an object of the present invention to provide a method for the production of polyvinyl alcohol, which is characterized by preventing gelation during the conversion of polyvinyl ester into polyvinyl alcohol, with a high degree of saponification, a high degree of polymerization, and high apparent gravity in a high concentration polyvinyl ester solution, reducing the amount of solvent used and thereby requiring a smaller reactor, leading to the reduction of apparatus cost and solvent recovery cost.

It is another object of the present invention to provide an apparatus for the production of polyvinyl alcohol which is suitable for the method of the present invention.

[Technical Solution]

To achieve the above objects, the present invention provides a method of producing polyvinyl alcohol based on the saponification of a mixture containing polyvinyl ester solution and a catalyst, wherein saponification is induced in a reactor equipped with a planetary stirrer coated with one or more coating agents selected from a group consisting of fluororesin, silicon resin and epoxy resin.

The present invention also provides an apparatus for the production of polyvinyl alcohol based on the saponification of a mixture containing polyvinyl ester solution and a catalyst, which is characteristically composed of a polyvinyl ester solution input line; a catalyst input line; a reactor equipped with a planetary stirrer coated with one or more coating agents selected from a group consisting of fluororesin, silicon resin and epoxy resin; and a neutralizer input line.

### DESCRIPTION OF DRAWINGS

The above and other objects, features and advantages of the present invention will become apparent from the following description of preferred embodiments given in conjunction with the accompanying drawing, in which:

FIG. 1 is a schematic diagram illustrating the process of preparing polyvinyl alcohol of the present invention.

### EXPLANATION OF REFERENCE NUMERALS FOR MAIN COMPONENTS IN THE DRAWINGS

1: catalyst solution input line

2: polyvinyl ester solution input line

3: in-line mixer

4: planetary stirrer

5: stirring support

6: polyvinyl alcohol slurry recovery line

7: grinding mixer

8: neutralizer input line

### BEST MODE

Hereinafter, the embodiments of the present invention will be described in detail with reference to the accompanying drawings.

The present invention relates to a method and an apparatus for the production of polyvinyl alcohol comprising an in-line mixer for stirring the high viscosity polyvinyl ester solution together with a catalyst solution such as an acid or alkali solution, and a planetary stirrer coated with one or more coating agents selected from a group consisting of fluororesin, silicon resin and epoxy resin, which is designed to overcome the problem of adherence of the polyvinyl alcohol to the rod or the blade of the stirrer from ‘rod climbing’ caused by the high viscosity of the solution during the saponification of the mixture of polyvinyl ester and the catalyst into polyvinyl alcohol.

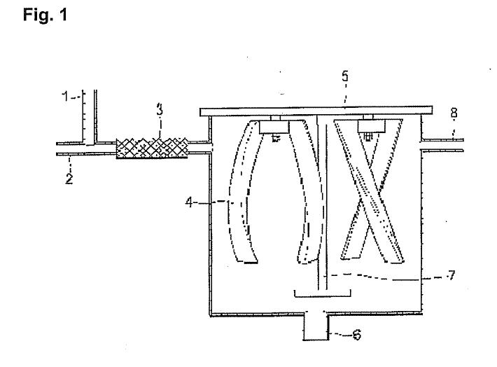

The process of preparing polyvinyl alcohol of the present invention is described as follows with reference to FIG. 1.

First, polyvinyl ester solution and a catalyst are inserted into the polyvinyl ester solution input line (2) and the catalyst solution input line (1) respectively and then mixed therein. The mixture is stirred further in the in-line mixer (3).

The mixture is stirred in the reactor equipped with the planetary stirrer (4) attached on the stirring support (5), leading to the saponification. The reactor can additionally be equipped with a grinding mixer (7).

Upon completion of the saponification, a neutralizer is inserted into the neutralizer input line (8) to produce polyvinyl alcohol slurry. The obtained slurry is recovered through the slurry recovery line (6).

The method for production of polyvinyl alcohol according to the present invention is characterized by the saponification occurring in a reactor equipped with a planetary stirrer coated with one or more coating agents selected from a group consisting of fluororesin, silicon resin and epoxy resin.

The method for the production of polyvinyl alcohol according to the present invention is composed of the following steps:

(a) Mixing polyvinyl ester solution and a catalyst;

(b) Inducing saponification of the mixture in a reactor equipped with a coated planetary stirrer; and

(c) Adding a neutralizer upon completion of the saponification.

(a) Mixing Polyvinyl Ester Solution and a Catalyst

In step (a), a catalyst necessary for the reaction is added to the polyvinyl ester solution and then mixed.

Polyvinyl alcohol cannot be prepared by direct polymerization with vinyl alcohol monomers because of the tautomerization of vinyl alcohol. Thus, in general, polyvinyl ester is first produced by the polymerization of vinyl ester monomers and then saponification of the produced polyvinyl ester is induced to prepare polyvinyl alcohol.

For the polymerization of polyvinyl ester, solution-, suspension-, emulsion- or mini emulsion polymerization can be used, and suspension polymerization is more preferred. To prepare polyvinyl alcohol with a high degree of polymerization, it is important to inhibit the formation of arms during the polymerization of polyvinyl ester and the length of the major chain has to be long. Thus, suspension polymerization is more generally accepted than solution polymerization or emulsion polymerization which cannot prevent the formation of arms.

Monomers for the preparation of polyvinyl ester can be one or more vinyl ester monomers selected from a group consisting of vinyl formate, vinyl acetate, vinyl propionate, vinyl valerianate, vinyl urate and vinyl stearate, and vinyl acetate is more preferably used to prepare polyvinyl alcohol with a high degree of polymerization.

For the polymerization of polyvinyl ester, a generally acceptable initiator, a suspension stabilizer and water can be added to the monomer.

As a polymerization initiator, peroxy compounds such as diisopropyl peroxydicarbonate, isobutyl peroxide, bis(4-tertiary-butylcyclohexyl)peroxycarbonate, acetyl cyclohexylsulfonyl peroxide, di-normal-propyl peroxycarbonate and alpha-cumyl-peroxyneodecanoate or azo compounds such as 2,2′-azobis-(4-methoxy-2,4-dimethylvaleronitrile), 2,2′-azobisisobutyronitrile, etc, can be used.

As a suspension stabilizer, polyvinyl alcohol with a degree of saponification of 88%, Arabia gum, hydroxyethylcellulose, methylcellulose, starch, polyacryl salt, polymethacryl salt, gelatin or an equimolar copolymer of styrene-maleic anhydride neutralized with sodium hydroxide or ammonia water can be used.

The preferable content of the monomer in water is 1˜300 weight part, the preferable content of the initiator in the monomer is 0.05˜10 weight part, and the preferable content of the suspension stabilizer in the monomer is 0.01˜10 weight part.

The polyvinyl ester produced by the suspension polymerization is filtered, washed and dried to prepare the final polyvinyl ester particles.

The water content of the produced polyvinyl ester is preferably up to 30%. If the water content is more than 30%, the amount of catalyst used for saponification increases rapidly, thereby lowering the degree of saponification.

The polyvinyl ester can be prepared in the form of a sphere, cylinder and cube, but sphere-shaped polyvinyl ester is more preferred.

It is also preferred for the polyvinyl ester to have a particle diameter of 10˜5000 μm for easy shipping and handling.

The viscosity of a 4% aqueous solution of the final polyvinyl alcohol prepared by the saponification of the polyvinyl ester prepared above is preferably 130˜230 cp at 30° C.

The polyvinyl ester solution can be prepared by dissolving the polyvinyl ester in an alcohol solvent, preferably in methanol.

The preferable content of polyvinyl ester in the polyvinyl ester solution is 5˜30 weight %. If the content is less than 5%, the viscosity is reduced, suggesting that saponification can be easily induced during the preparation of polyvinyl ester solution but the amount of a solvent used increases, thereby increasing the production cost of the polyvinyl alcohol because the apparatus for the production of the polyvinyl ester solution and the reactor for the saponification have to be bigger. If the content is more than 30%, the viscosity of the polyvinyl ester solution increases rapidly, resulting in difficulty in shipping and handling, and the production of the polyvinyl ester solution takes more time because the polyvinyl ester, a solute, is insoluble in methanol, a solvent.

The polyvinyl ester solution can additionally contain hydrogen peroxide solution before stirring with a catalyst or can be treated with ozone in order to improve the thermo-stability and color of the polyvinyl alcohol. By this addition or treatment, double bonds at the terminal of polyvinyl ester form aldehyde groups during the saponification, which can prevent a decrease of the thermo-stability of the final product.

The catalyst used herein can be one of the strong inorganic acids such as hydrochloric acid, sulfuric acid and phosphoric acid, or bases such as sodium hydroxide, sodium phosphate and sodium methoxide. Among those catalysts, bases are preferred and more specifically sodium hydroxide is more preferred.

The catalyst can be used as a solution prepared by mixing with water or an alcohol solvent.

The preferable content of the catalyst is 0.2˜10 weight part for 100 weight part of polyvinyl ester. If the content is less than 0.2 weight part, the reaction speed becomes too slow. On the contrary, if the content is more than 10 weight part, the reaction speed becomes so fast as to form a huge lump of particles and thereby salt is mass-produced after polymerization. So, a huge amount of washing solution is required and the produced salt can reduce the thermo-stability of the polyvinyl alcohol.

The step of mixing polyvinyl ester solution and a catalyst (a) can additionally include the sub-step of stirring the mixture in an in-line mixer.

(b) Inducing Saponification of the Mixture in a Reactor Equipped with a Coated Planetary Stirrer

In step (b), the mixture stirred in step (a) is put in a reactor equipped with a coated planetary stirrer, the apparatus of the present invention, for saponification. This apparatus for the production of polyvinyl alcohol is designed to reduce the gelation caused by the progress of saponification by using the coated planetary stirrer, which enables the production of polyvinyl alcohol slurry by converting the polyvinyl ester into polyvinyl alcohol particles without rod climbing.

The apparatus for the production of polyvinyl alcohol of the present invention, used to induce saponification of the mixture of polyvinyl ester and catalyst solution, comprises a polyvinyl ester solution input line; a catalyst input line; a reactor equipped with a planetary stirrer coated with one or more coating agents selected from a group consisting of fluororesin, silicon resin and epoxy resin; and a neutralizer input line.

The planetary stirrer is preferably coated with one or more coating agents selected from a group consisting of fluororesin such as polytetrafluoroethylene, fluorilatedethylenepropylene copolymer or ethylenetetrafluoroethylene, silicon resin and epoxy resin and more preferably coated with ethylenetetrafluoroethylene, which has an excellent non-stick property and strength as well as excellent chemical resistance and thermal resistance. If another planetary stirrer coated with a different coating agent from the above agents is used, it is difficult to control the polarity of the polyvinyl alcohol particles, resulting in the adherence of those particles to the stirrer, suggesting that the recovery of the particles is difficult and thereby the stirrer cannot fully function.

The planetary stirrer is not limited to a specific type, but a screw shaped stirrer is preferred since it is able to minimize the non-mixing region (dead-zone).

The possible number of planetary stirrers used is 1˜4.

The apparatus for the production of polyvinyl alcohol of the present invention can also include a grinding mixer in addition to the planetary stirrer.

The grinding mixer is located in the dead zone and rotates independently during the rotation of the planetary stirrer, whereby the grinding mixer revolves on the rod of the stirrer together with the planetary stirrer.

The grinding mixer can be coated with the same coating agents as used for the coating of the planetary stirrer.

The grinding mixer can use a propeller, paddle, turbine or disc impeller as an impeller.

In the step of saponification (b), the grinding step can be additionally included during or after the saponification to pulverize the product into even particles by using the grinding mixer.

Particularly, the grinding step using the grinding mixer can be included in the early stage of saponification or in the late stage of the saponification when big particles have already been generated. If the grinding step is introduced from the early stage of saponification, very small size particles can be obtained, whereas if the grinding step is introduced in the late stage of the saponification when huge particles are already formed, particles with high apparent gravity can be obtained.

The preferable reaction temperature for the saponification is −10˜90° C., and more preferably 35˜60° C. If the reaction temperature is lower than −10° C., the reaction speed reduces significantly. On the other hand, if the reaction temperature is higher than 90° C., methyl acetate is produced during the saponification of polyvinyl ester, causing a loss of sodium hydroxide catalyst and thereby making the production of polyvinyl alcohol with a high degree of saponification difficult.

(c) Adding a Neutralizer

In this step, a neutralizer is added upon completion of the saponification (b) to give a polyvinyl alcohol slurry.

The selection of the neutralizer depends on the catalyst used. For example, if the catalyst is a base, an acidic neutralizer is selected whereas if the catalyst is an acid, a basic neutralizer is selected.

The preferable content of the neutralizer is 0.5˜2 mol per mol of the catalyst.

The produced polyvinyl alcohol slurry is filtered, washed and dried to give polyvinyl alcohol particles.

Practical and presently preferred embodiments of the present invention are illustrated as shown in the following examples. However, it will be appreciated that those skilled in the art, upon consideration of this disclosure, may make modifications and improvements within the spirit and scope of the present invention.

### EXAMPLE 1

To a reactor equipped with a thermometer, a nitrogen inflow hole, a condensation device, a baffle and a pitch-paddle stirrer were added a mixture of vinyl acetate and water (1:2, weight ratio), polyvinyl alcohol having a degree of saponification of 88% (polymerization degree: 1800) as a suspension stabilizer by the weight ratio to vinyl acetate of 1:1×10⁻⁴, and 2,2′-azobis-(4-methoxy-2,4-dimethylvaleronitrile) as a polymerization initiator by the weight ratio to vinyl acetate of 1:0.003. To the reactor were added water and a suspension stabilizer, followed by stirring during which nitrogen was blown strongly under the surface of the water for 2 hours to eliminate dissolved oxygen. Vinyl acetate was purified in the presence of nitrogen to eliminate the polymerization terminator and dissolved oxygen. The purified vinyl acetate was added to the reactor and then the reaction temperature was raised to 40° C., followed by polymerization for 6 hours in the presence of nitrogen. Upon completion of the polymerization, polyvinyl acetate slurry was filtered using an aspirator, washed thoroughly with distilled water and vacuum dried at 30° C. for 24 hours under 1 mmHg to give polyvinyl acetate with a water content of up to 0.4%.

10% polyvinyl acetate solution was prepared by adding the prepared polyvinyl acetate to methanol. Sodium hydroxide was added as a catalyst to polyvinyl acetate at the molar ratio of 1:0.03, and was introduced to the polyvinyl acetate solution through the in-line mixer. Saponification was induced by stirring in the reactor, which was additionally equipped with a planetary stirrer coated with ethylenetetrafluoroethylene and a grinding mixer, at 40° C. for one hour. The stirring speed of the planetary stirrer was 43 rpm and the stirring speed of the grinding mixer was 1000 rpm.

Upon completion of the saponification, an equal amount of acetic acid to sodium hydroxide was added, followed by stirring for 10 minutes. After neutralization, polyvinyl alcohol slurry was obtained.

The obtained polyvinyl alcohol slurry was filtered by using an aspirator, washed thoroughly with methanol, and vacuum-dried at 30° C. for 12 hours under 1 mmHg to give polyvinyl alcohol with a methanol content of up to 0.3%.

### EXAMPLE 2

An experiment was performed in the same manner as described in Example 1, except that a reactor not equipped with the grinding mixer was used for saponification.

### EXAMPLE 3

An experiment was performed in the same manner as described in Example 1, except that 15% polyvinyl acetate solution prepared by dissolving polyvinyl acetate in methanol was used.

### EXAMPLE 4

An experiment was performed in the same manner as described in Example 1, except that the filtered polyvinyl alcohol was re-introduced in the same reactor and methanol was added thereto to adjust the slurry content to 6.5%, and then the reaction temperature was raised to 40° C. followed by saponification for one hour, after adding sodium hydroxide to polyvinyl acetate at the weight ratio of 1:0.03.

### COMPARATIVE EXAMPLE 1

An experiment was performed in the same manner as described in Example 1, except that a reactor equipped with a turbine type impeller was used for saponification of the slurry. The stirring speed of the impeller was 1700 rpm.

### COMPARATIVE EXAMPLE 2

An experiment was performed in the same manner as described in Comparative Example 1, except that 5% polyvinyl acetate solution was used.

### COMPARATIVE EXAMPLE 3

An experiment was performed in the same manner as described in Comparative Example 1, except that 7% polyvinyl acetate solution was used.

### COMPARATIVE EXAMPLE 4

An experiment was performed in the same manner as described in Example 1, except that the reactor was equipped with a non-coated planetary mixer and grinding mixer.

The physical properties of polyvinyl alcohols produced in the examples and comparative examples were tested as follows and the results are shown in Table 1.
Concentration of polyvinyl acetate (wt %): measured by the below formula.
   Weight of polyvinyl acetate/Mass of polyvinyl acetate solution×100
Degree of saponification (Mol %): measured by H-NMR peak.
Particle size: the particle size right after drying was measured before the polyvinyl alcohol particles were pulverized with a mixer.
Adhesiveness (wt %): calculated by the following formula after measuring the adherence of particles onto the stirrer.
   100 Weight of the adhered polyvinyl alcohol/Total mass of polyvinyl alcohol×100
Apparent gravity: The produced polyvinyl alcohol was put in the mixer and pulverized, so that polyvinyl alcohol particles of an even size were prepared. Then, the apparent gravity was measured by ASTM D1895.

Weight average Molecular Weight: measured by the method of JAPAN INDUSTRIAL STANDARD JIS K-6726-1977.

TABLE 1

| | Example | | | | Comparative Example | | | |
|---|---|---|---|---|---|---|---|---|
| | 1 | 2 | 3 | 4 | 1 | 2 | 3 | 4 |
| PVAc(wt %) | 10 | 10 | 15 | 10 | 10 | 5 | 7 | 10 |
| Shape | Particle | Particle | Particle | Particle | Lump | Particle | Lump | Particle + Lump |
| Particle Size (mm) | 1˜3 | 3˜10 | 2˜4 | 1˜3 | NA | 0.1˜4 | NA | 2˜5 |
| Adhesiveness | 0.1 | 0.1 | 0.5 | 0.1 | 88 | 1 | 69 | 30 |
| Degree of Saponification (mol %) | 99.1 | 98.5 | 99.3 | ≧99.9 | 90 | 95.4 | 91 | 98.9 |
| Apparent gravity (g/cm³) | 0.6 | 0.61 | 0.63 | 0.61 | — | 0.42 | — | 0.6. |

As shown in Table 1, polyvinyl alcohols produced in Examples 1˜4 by using the apparatus for the production of polyvinyl alcohol equipped with the coated planetary stirrer according to the present invention were confirmed to have an excellent degree of saponification, a high degree of polymerization and high apparent gravity, compared with the polyvinyl alcohol produced in Comparative Examples 1 or 3, wherein the conventional turbine shaped impeller was used for the reaction and thereby insoluble gel formation was not inhibited and slurry could not be obtained, or the polyvinyl alcohol produced in Comparative Example 2, which exhibited low apparent gravity, a low degree of saponification, and large distribution of particles. In the meantime, the polyvinyl alcohol produced in Comparative Example 4 by using a non-coated planetary stirrer adhered to the stirrer, so that the yield of the usable particles was reduced. Polyvinyl alcohol produced in Example 2 without using a grinding mixer was confirmed to be shapeless, that is some of the particles were long, some were round and some were cubes.

### INDUSTRIAL APPLICABILITY

As explained hereinbefore, an apparatus equipped with a coated planetary stirrer is very helpful at inhibiting the generation of a huge lump caused by gelation during the conversion of polyvinyl ester to polyvinyl alcohol. Thus, the method and the apparatus for the production of polyvinyl alcohol according to the present invention have the advantages of producing polyvinyl alcohol with a high degree of saponification, a high degree of polymerization and high apparent gravity even in highly concentrated polyvinyl ester solution, there is a dramatic reduction of the amount of solvent used, thereby requiring a smaller reactor resulting in a reduction of the apparatus cost and solvent recovery cost.

Those skilled in the art will appreciate that the conceptions and specific embodiments disclosed in the foregoing description may be readily utilized as a basis for modifying or designing other embodiments for carrying out the same purposes of the present invention. Those skilled in the art will also appreciate that such equivalent embodiments do not depart from the spirit and scope of the invention as set forth in the appended claims.

1. A method for the production of polyvinyl alcohol based on the saponification of a mixture of a polyvinyl ester solution and a catalyst, wherein the saponification is induced in a reactor equipped with a planetary stirrer coated with one or more coating agents selected from a group consisting of fluororesin, silicon resin and epoxy resin.

2. The method for the production of polyvinyl alcohol according to claim 1, which is composed of the following steps:
(a) Mixing a polyvinyl ester solution and a catalyst;
(b) Inducing saponification of the mixture in a reactor equipped with a planetary stirrer coated with one or more coating agents selected from a group consisting of fluororesin, silicon resin and epoxy resin; and
(c) Adding a neutralizer upon completion of the saponification.

3. The method for the production of polyvinyl alcohol according to claim 2, wherein the mixing of the polyvinyl ester solution and the catalyst of step (a) is performed by stirring the mixture using an in-line mixer.

4. The method for the production of polyvinyl alcohol according to claim 2, wherein step (b) of the saponification characteristically includes pulverization with a grinding mixer to produce even particles at the time of, or after, the saponification.

5. The method for the production of polyvinyl alcohol according to claim 1, wherein the catalyst is selected from a group consisting of hydrochloric acid, sulfuric acid, phosphoric acid, sodium hydroxide, sodium phosphate and sodium methoxide.

6. The method for the production of polyvinyl alcohol according to claim 1, wherein the content of the catalyst is 0.2˜10 weight part for 100 weight part of the polyvinyl ester.

7. The method for the production of polyvinyl alcohol according to claim 1, wherein the content of polyvinyl ester in the polyvinyl ester solution is 5˜30 weight %.

8. The method for the production of polyvinyl alcohol according to claim 1, wherein the reaction temperature for the saponification is −10˜90° C.

9. The method for the production of polyvinyl alcohol according to claim 2, wherein the content of the neutralizer is 0.5˜2 mol per mol of the catalyst.

10. An apparatus for the production of polyvinyl alcohol, wherein a mixture of polyvinyl ester solution and a catalyst are saponified, which comprises a polyvinyl ester solution input line; a catalyst input line; a reactor equipped with a planetary stirrer coated with one or more coating agents selected from a group consisting of fluororesin, silicon resin and epoxy resin; and a neutralizer input line.

11. The apparatus for the production of polyvinyl alcohol according to claim 10, wherein the fluororesin is polytetrafluoroethylene, fluorilatedethylenepropylene copolymer or ethylenetetrafluoroethylene.

12. The apparatus for the production of polyvinyl alcohol according to claim 10, wherein the apparatus contains 1˜4 stirrers.

13. The apparatus for the production of polyvinyl alcohol according to claim 10, wherein the apparatus includes an in-line mixer for stirring the mixture of the polyvinyl ester solution and the catalyst.

14. The apparatus for the production of polyvinyl alcohol according to claim 10, wherein the apparatus includes a grinding mixer.

15. The apparatus for the production of polyvinyl alcohol according to claim 14, wherein the grinding mixer is coated with one or more coating agents selected from a group consisting of fluororesin, silicon resin and epoxy resin.

16. The apparatus for the production of polyvinyl alcohol according to claim 14, wherein the grinding mixer uses one of a propeller, paddle, turbine and disc impeller as an impeller.
